(19) United States
(12) Patent Application Publication
(10) Pub. No.: US 2024/0328450 A1
(43) Pub. Date: Oct. 3, 2024

(54) QUICK INSTALL NUT

(71) Applicant: Globe Union Industrial Corp., Taichung City (TW)

(72) Inventors: CHAO-TA YANG, Taichung City (TW); HIS-TSUNG CHEN, Taichung City (TW)

(21) Appl. No.: 18/537,257

(22) Filed: Dec. 12, 2023

(30) Foreign Application Priority Data
Mar. 27, 2023 (CN) 2023206219360

(51) Int. Cl. F16B 37/08

(52) U.S. Cl. CPC F16B 37/0814

(57) ABSTRACT

A quick install nut is provided. The nut includes an entrance end, an exit end, a first threaded portion corresponding to the entrance end, a second threaded portion corresponding to the exit end and connected with the first threaded portion. The first threaded portion includes a first slot, a segment of first internal thread formed in the first slot, and a first relief space communicating with the first slot radially. The second threaded portion includes a second slot, a segment of second internal thread formed in the second slot, and a second relief space communicating with the second slot radially. The first and the second slots are disposed on a central axis in a staggered manner. A compression wall is formed on the first threaded portion. After being tilted, the nut is placed and moved along a threaded fastener and returned to achieve fast and firm fastening.

### BACKGROUND OF THE INVENTION

The present invention relates to a nut, especially to a quick install nut.

### PRIOR ART

Many device, equipment or accessories need to be used together with threaded fasteners including threaded rods, bolts, threaded inserts, etc. These threaded fasteners are often used in combination with nuts for threading and fastening. In many cases, the nut is rotated and moved on the threaded fastener over a long distance for fastening. Thus some problems occur such as long time required for threading, or reduced operation efficiency. Narrow space for installation and operation does not facilitate rotation of the nut over the long distance. It's even difficult to apply a rotational force and tightening of the nut on the bolt is affected.

In order to solve the shortcomings of the conventional nuts mentioned above, a fast tightening nut is revealed in Chinese Pat Pub. No. 206738362 U. The nut includes a main body provided with a threaded hole and a through hole. An axis of the threaded hole is vertical while an axis of the through hole is tilted. The axis of the threaded hole and the axis of the through hole are on the same plane and an angle between them is an acute angle. A part of threads in the threaded hole is removed by the design of the through hole. While in use, the threaded hole is inclined and a threaded rod is allowed to insert through the through hole and stop in place quickly. Lastly, the nut is returned to its normal position and tighten the main body of the nut on the threaded rod through the threaded hole. Thereby the nut is installed quickly.

However, the nut with the above design still has certain shortcomings. For instance, the threaded hole is completely enclosed in the main body so that internal threads on the inner surface of the threaded hole can't be formed integrally by design of draft. First the whole threaded hole and internal threads are produced by metal forming. Then a part of internal threads is removed by drilling the through hole. Thereby production of the internal threads and the through hole is limited to metal forming, unable to be integrally formed with molds and plastic materials. The production efficiency is restricted and materials used are limited to expensive metal materials. Thus costs for materials and manufacturing are unable to be reduced.

The nut is designed with the through hole to avoid outer threads of the threaded rod for allowing quick insert of the threaded rod through the through hole. Yet the design of the closed through hole also limits a space for relief of the threaded rod and a tilt angle of the nut allowed to tilt is restricted. When the nut needs to be design into slender, the above design with the closed through hole is unable to provide sufficient space for relief. This is to possible engagement or contact between the outer threads of the threaded rod and the inner threads of the threaded hole. Thus the inclined nut is unable to move along the threaded rod smoothly and its applications are significantly reduced.

### SUMMARY OF THE INVENTION

Therefore, it is a primary object of the present invention to provide a quick install nut which is easy and convenient to use, labor-saving, and having fast and secure fastening effect. Thus the quick install nut can be applied to installation and fastening of bathroom equipment or accessories such as various types of faucets and toilets.

In order to achieve the above object, a quick install nut according to the present invention includes an entrance end, an exit end, a half-shell first threaded portion corresponding to the entrance end, and a half-shell second threaded portion corresponding to the exit end and connected with the first threaded portion. The first threaded portion consists of a first slot, a segment of first internal thread formed in the first slot, and a first relief space communicating with a radial opening of the first slot. The second threaded portion is composed of a second slot, a segment of second internal thread formed in the second slot, and a second relief space communicating with a radial opening of the second slot. The first slot and the second slot are disposed on a central axis in a staggered manner so that the radial openings are in opposite directions with a 180-degree angle between them and a compression wall is formed on the first threaded portion.

Preferably, the fast install nut can be placed on and moved along various threaded fasteners including threaded rods, bolts, threaded inserts, etc. without hindrance by being tilted at an angle. Then threading and fastening with extremely short movement is performed after being returned to the original direction. Thereby quick fastening or clamping for installation is achieved.

By the first relief space and the second relief space formed at corresponding positions of the first internal thread and the second internal thread, and the crossing space formed between the first threaded portion 13 and the second threaded portion, the nut can be directly produced by molding of plastic materials with molds. Some conventional nuts are unable to be produced by molds (due to draft angle) and thus only able to be produced by metal processing. The design of the present nut can overcome the above problem and have many advantages including fast production, lower cost of materials and manufacturing, light weight, etc.

The nut is getting closer to the surface going to be compressed while moving on the threaded fastener by the design of the slanting surface formed on each of two ends of the compression wall of the first threaded portion. Thus rotation movement required for threading and fastening after the nut being aligned is reduced and assembly speed is further increased.

The installers can perform final threading and tightening using specific or general wrench tools by the mounting-and-locking peripheral wall or the locking portion on the nut. Thereby specific operation and installation are more convenient, labor-saving, fast and firm.

By open design of the first relief space, the second relief space, and the crossing space, the present nut is allowed to have the tilted angle with larger range in response to nuts designed with different sizes and specifications and various installations and applications, without worrying about relief effect. The relief effect of the nut is far more better than conventional quick fastening nut.

### BRIEF DESCRIPTION OF THE FIGURES

FIG. 1 is a perspective view of an embodiment of a nut according to the present invention;

FIG. 2 is another perspective view of an embodiment of a nut according to the present invention;

FIG. 3 is a top plan view of the embodiment in FIG. 1 according to the present invention;

FIG. 4 is a sectional view along a line 1-1 of the embodiment in FIG. 3 according to the present invention;

FIG. 5 is a schematic drawing showing an embodiment applied to installation of a single-hole single-shank basin faucet according to the present invention;

FIG. 6 is a partial side sectional view of the embodiment in FIG. 5 according to the present invention;

FIG. 7 is a schematic drawing showing an embodiment being installed on a shank according to the present invention;

FIG. 8 is a schematic drawing showing an embodiment applied to installation of a two-piece toilet according to the present invention;

FIG. 9 is a perspective view of another embodiment of a nut according to the present invention;

FIG. 10 is another perspective view of another embodiment of a nut according to the present invention;

FIG. 11 is a schematic drawing showing another embodiment applied to installation of a side-fastened toilet according to the present invention;

FIG. 12 is an exploded view of the embodiment in FIG. 11 showing main components according to the present invention;

FIG. 13 is a schematic drawing showing another embodiment applied to installation of a toilet with exposed drain pipes according to the present invention;

FIG. 14 is a perspective view of a third embodiment of a nut according to the present invention;

FIG. 15 is another perspective view of a third embodiment of a nut according to the present invention;

FIG. 16 is a schematic drawing showing a third embodiment applied to installation of a side-fastened toilet according to the present invention;

FIG. 17 is a perspective view of a fourth embodiment of a nut according to the present invention;

FIG. 18 is another perspective view of a fourth embodiment of a nut according to the present invention;

FIG. 19 is a side sectional view of the embodiment in FIG. 17 according to the present invention;

FIG. 20 is a schematic drawing showing a fourth embodiment applied to installation of a side-fastened toilet according to the present invention;

FIG. 21 is a perspective view of a fifth embodiment of a nut according to the present invention;

FIG. 22 is another perspective view of a fifth embodiment of a nut according to the present invention;

FIG. 23 is a side sectional view of the embodiment in FIG. 21 according to the present invention;

FIG. 24 is a schematic drawing showing a fifth embodiment applied to installation of a double-hole double-shank basin faucet according to the present invention;

FIG. 25 is a perspective view of a sixth embodiment of a nut according to the present invention;

FIG. 26 is another perspective view of a sixth embodiment of a nut according to the present invention;

FIG. 27 is a schematic drawing showing a sixth embodiment applied to installation of a single-hole double-shank basin faucet according to the present invention.

### DETAILED DESCRIPTION OF CERTAIN EMBODIMENTS

Please refer to the following embodiments together with related figures for explanation.

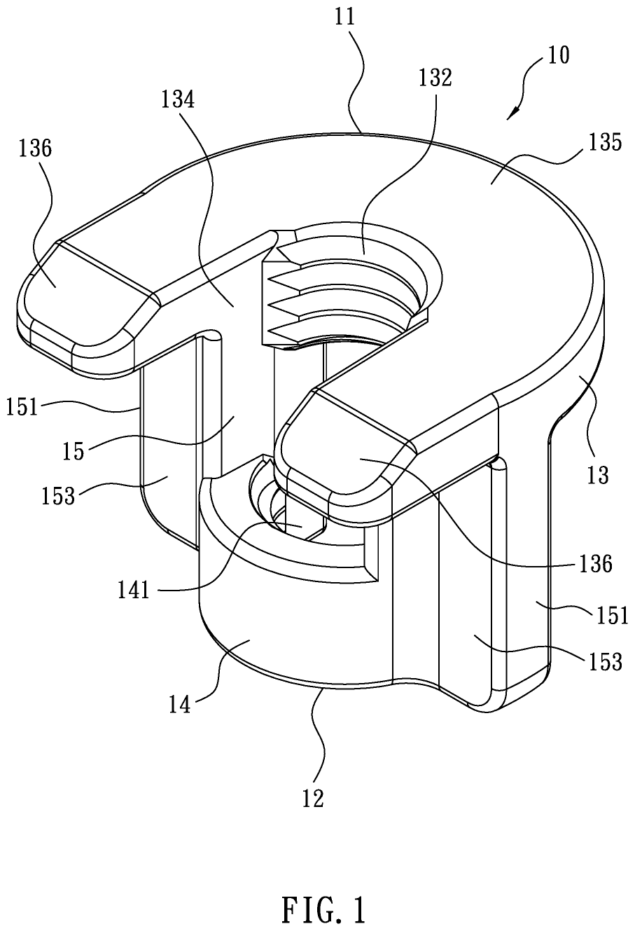

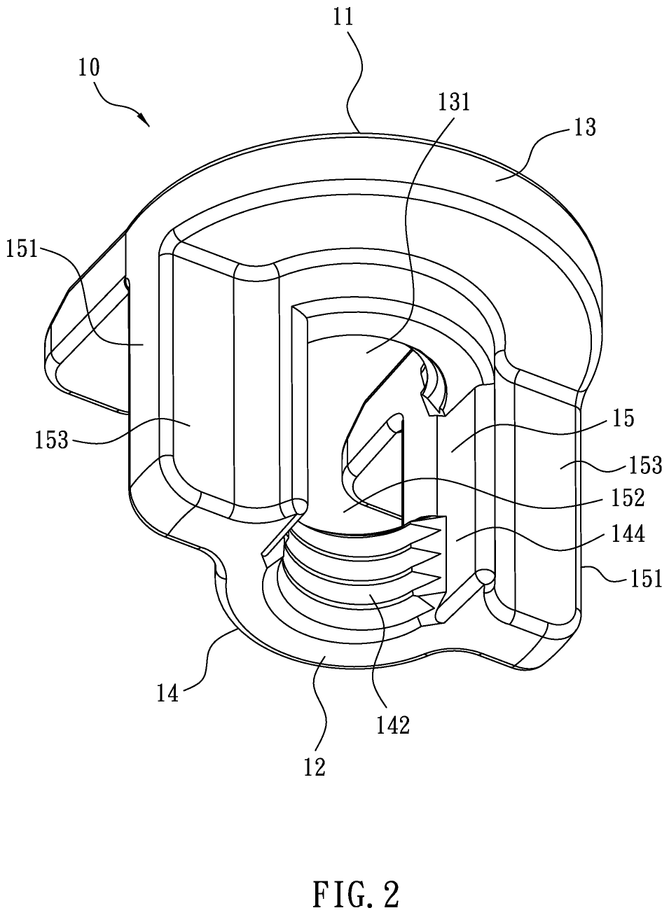

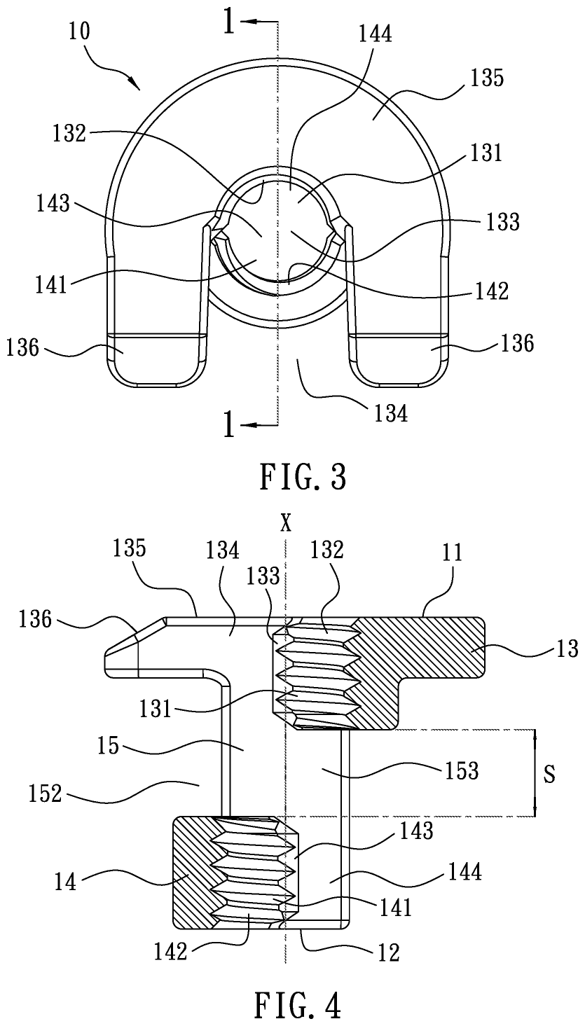

As shown in FIG. 1-4, a first embodiment of a quick assembly nut according to the present invention is provided. A nut 10 is used in combination with a threaded fastener such as a bolt, a threaded rod, or a threaded insert in various forms to fasten two objects with each other quickly or fasten the two objects onto a third object.

In this embodiment, the nut 10 includes an entrance end 11, an exit end 12, a half-shell first threaded portion 13 corresponding to the entrance end 11, a half-shell second threaded portion 14 corresponding to the exit end 12 and connected with the first threaded portion 13. The first threaded portion 13 consists of a first slot 131, a segment of first internal thread 132 formed on an inner surface of the first slot 131, a radial opening 133 of the first slot 131, and a first relief space 134 communicating with the radial opening 133 of the first slot 131. The second threaded portion 14 is composed of a second slot 141, a segment of second internal thread 142 formed on an inner surface of the second slot 141, a radial opening 143 of the second slot 141, and a second relief space 144 communicating with the radial opening 143 of the second slot 141. The first slot 131 and the second slot 141 are arranged at a central axis X in a staggered manner so that the radial openings 133, 143 are in opposite directions with a 180-degree angle between them. A compression wall 135 is formed on the first threaded portion 13.

In this embodiment, the first threaded portion 13 and the second threaded portion 14 have a certain distance S on the axis X between them and connected with each other by a connecting portion 15.

More specifically, the connecting portion 15 includes two connection ribs 151 correspondingly connected with two corresponding sides of the first threaded portion 13 and the second threaded portion 14. A crossing space 152 is defined among the connection ribs 151 and adjacent area and used for communicating with the first slot 131, the first relief space 134, the second slot 141, and the second relief space 144.

In this embodiment, each of the connection rib 151 is provided with a pulled surface 153 allowing users to hold and turn manually. The connection rib 151 is further extending and connected to outer wall surfaces on two opposite sides of the second threaded portion 14. Thus area of the pulled surface 153 is increased and this helps users contact with and apply a force to the pulled surfaces 153 with their fingers.

In this embodiment, the first internal thread 132 formed on the inner surface of the first slot 131 and the second internal thread 142 formed on the inner surface of the second slot 141 are distributed without over a semicircle in a circumferential direction. By such design, it is ensured that a corresponding part of the threaded fastener is allowed to be moved in or out through the radial opening 133 of the first slot 131 and the radial opening 143 of the second slot 141 freely while being assembled with the nut 10.

In this embodiment, the compression wall 135 of the first threaded portion 13 is U-shaped and provided a slanting surface 136 formed on each of two ends of the compression wall 135. By design of the slanting surface 136, assembly speed of the nut 10 with the threaded fastener is further improved.

The nut 10 of this embodiment can be used in combination with a threaded fastener such as a bolt, threaded rod, or threaded insert in various forms to fasten two objects with each other quickly. For example, the threaded fastener is inserted through corresponding walls of the two objects in turn, and then the nut 10 is placed and moved on the threaded fastener for quick assembly and screw fastening.

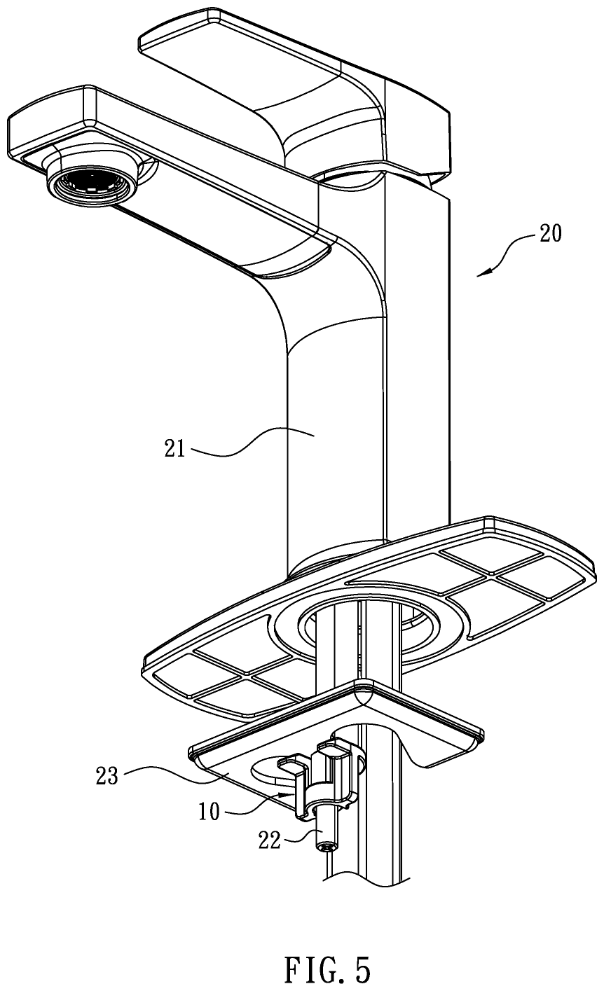

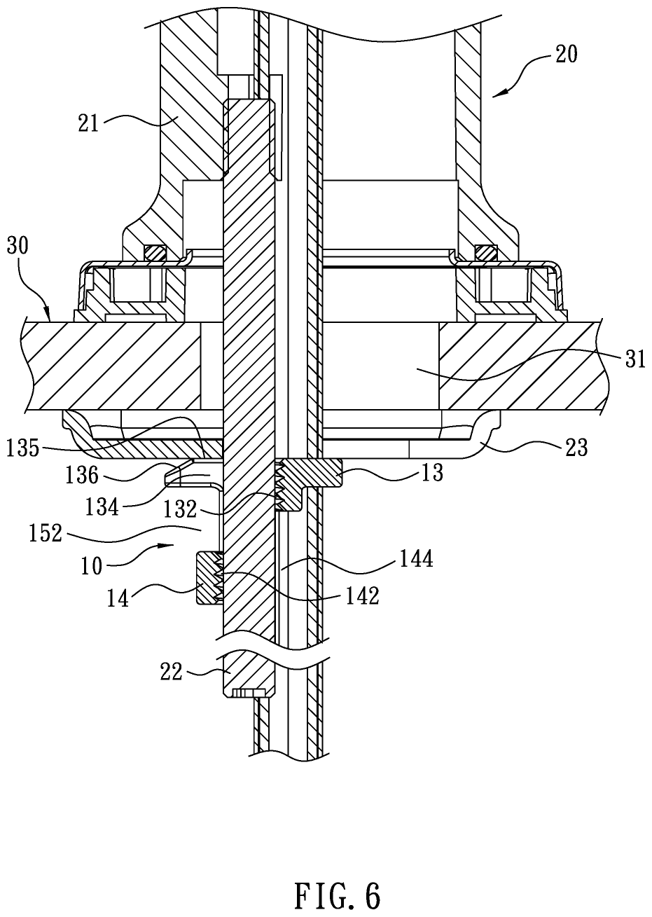

The nut 10 of the present embodiment is especially suitable for assembly and fastening of various types of bathroom equipment, device, or accessories. Take a single-hole single-shank basin faucet 20 as an example. As shown in FIG. 5 and FIG. 6, a threaded rod 22 is fixed in a main body 21 of the faucet 20. During assembly, the nut 10 is fastened on the threaded rod 22 after the threaded rod 22 being inserted down and through an assembly hole 31 of a basin 30. Thus the faucet 20 is quickly installed and fixed on the basin 30. A gasket 23 can be firstly fitted and positioned on the threaded rod 22 so that the gasket 23 is clipped between the nut 10 and a corresponding bottom wall surface of the basin 30 to increase firmness of the nut 10.

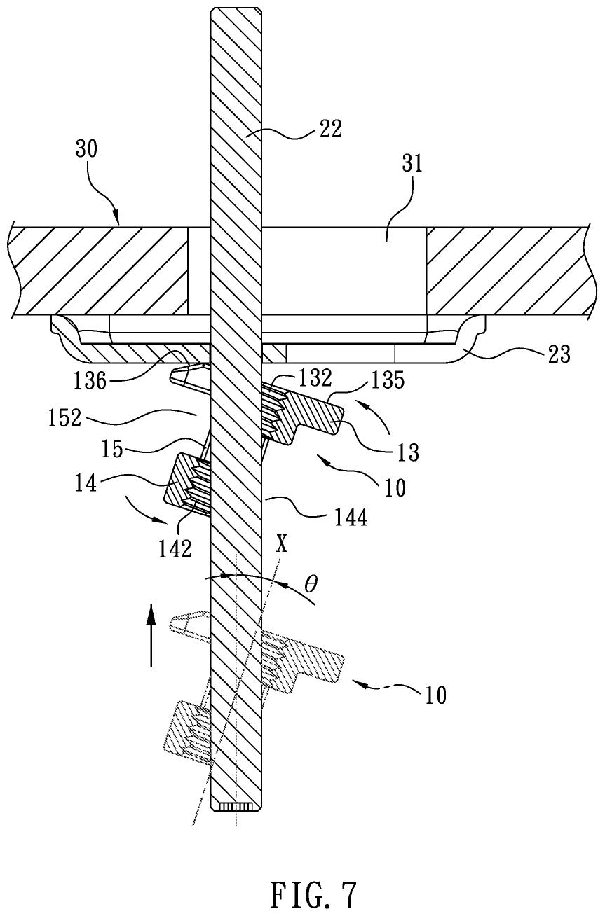

In more detail, when the threaded rod 22 is inserted through the assembly hole 31 of the basin 30 and the gasket 23 is fitted on the threaded rod 22, as shown in FIG. 7, users only need to tilt the nut 10 a bit and a rear end of the threaded rod 22 is allowed to insert through the first slot 131 and the first relief space 134 of the nut 10 smoothly and slantingly and further through the crossing space 152, the second slot 141, and the second relief space 144 slantingly. For example, the nut 10 is tilted at an angle θ with respect to a central axis of the threaded rod 22. Thereby the nut 10 is allowed to move along the threaded rod 22 quickly, reach a corresponding bottom surface of the gasket 23, and stop until the slanting surface 136 of the first threaded portion 13 abutting against the bottom surface of the gasket 23. As shown in FIG. 6, later the nut 10 is turned from above tilted state back to its normal (original) direction (being aligned with the threaded rod 22) so that the first internal thread 132 and the second internal thread 142 of the nut 10 are engaged with corresponding external threads 221 of the threaded rod 22 to be in a threaded state. Then the pulled surfaces 153 formed on the connection rib 151 are used to turn and tighten the nut 10 and the compression wall 135 is abutting against and compressed on the bottom surface of the gasket 23. Thereby the whole fastening process is completed easily and quickly and the faucet 20 is firmly secured to the basin 30.

In this embodiment, the tilted angle θ is between 14-22 degrees. Within such range, interference and obstruction of the first internal thread 132 and the second internal thread 142 can be avoided easily. Thus the nut 10 can be moved upward to the uppermost position quickly and then returned to the normal direction and threaded for fastening. It should be noted that the above tilted angle is only suitable for this embodiment. The range of the tilted angle θ may be different in different embodiments, not limited to the above range.

It should be noted that the design of the slanting surface 136 makes the nut 10 get closer to the bottom surface of the gasket 23 while being moved upward along with the threaded rod 22. After being returned to the normal direction, the nut 10 only needs to be rotated a bit for compression and tightening. Thereby assembly efficiency is further improved.

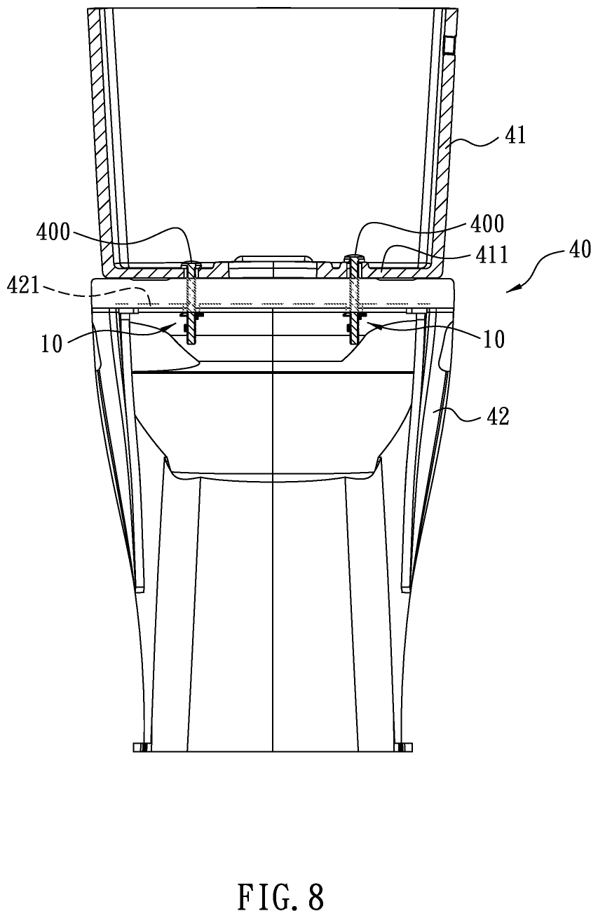

The nut 10 of this embodiment can also be used in a two-piece toilet 40, as shown in FIG. 8. More specifically, after two bolts 400 pointing downward being inserted through a bottom wall 411 of a toilet tank 41 and a corresponding wall 421 of a toilet bowl 42 in turn, the two nuts 10 are placed on and moved upward along the bolts 400 for threading and fastening. Thereby the toilet tank 41 is installed and fastened on the toilet bowl 42 quickly.

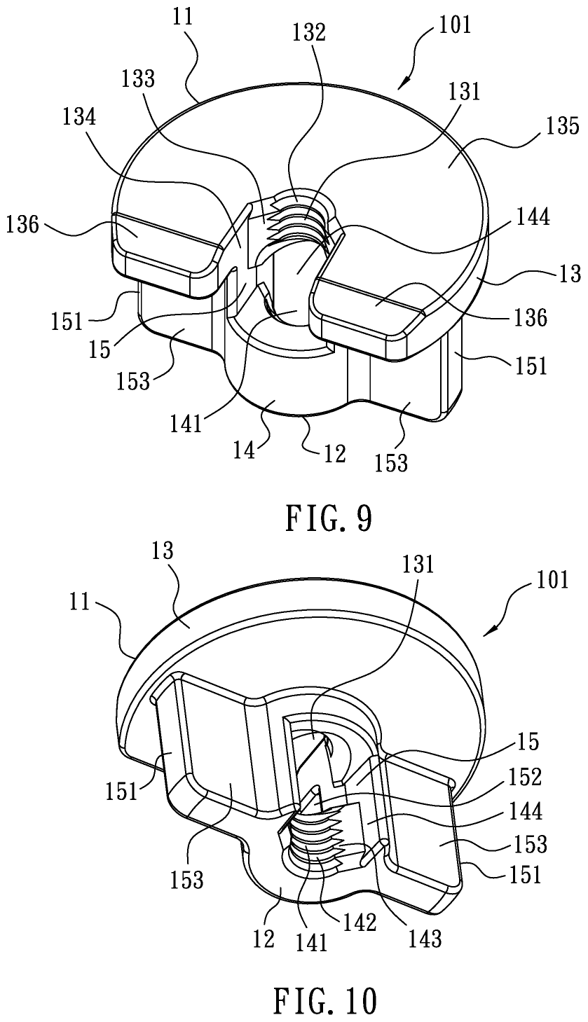

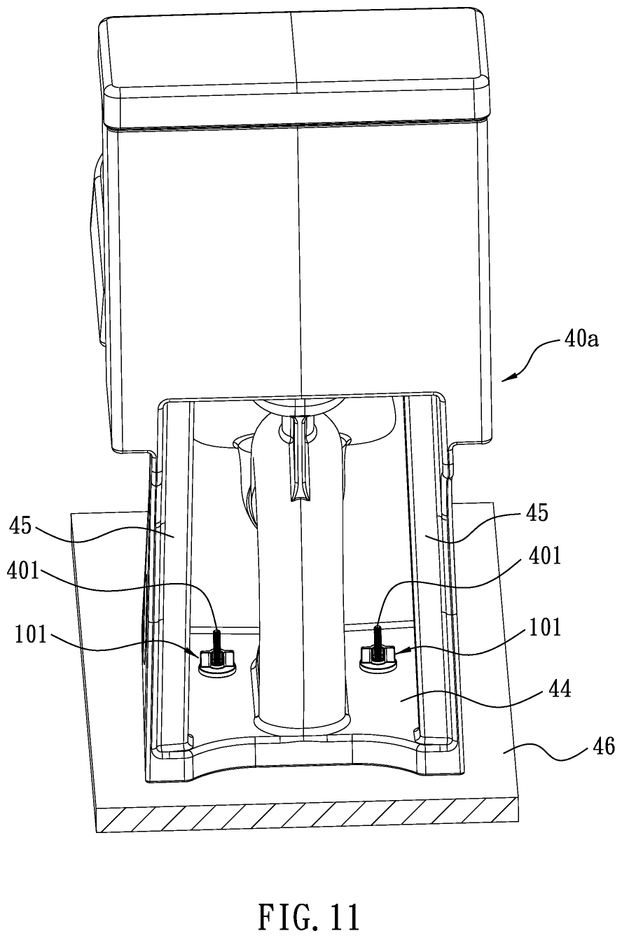

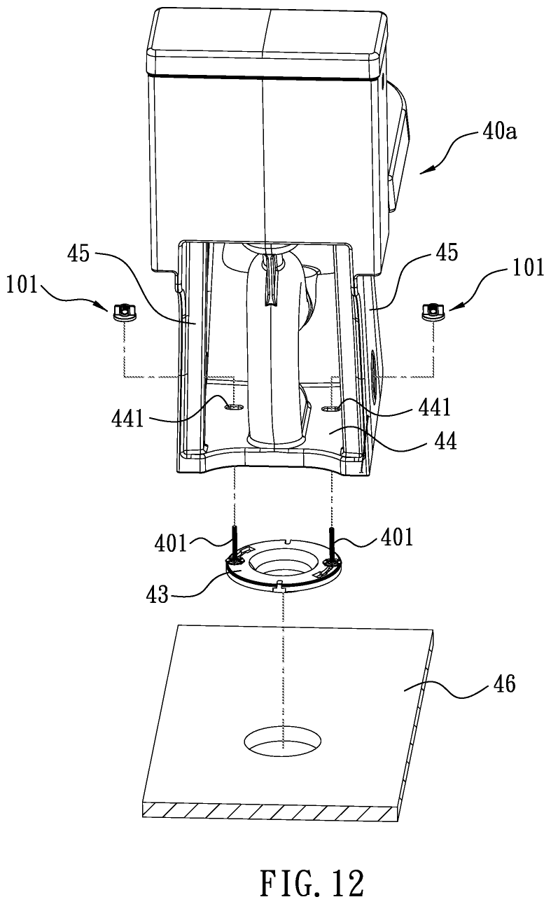

As shown in FIG. 9-12, another embodiment of a quick install nut according to the present invention is provided. A nut 101 of this embodiment has about the same structure as the nut 10 of the above embodiment and they are different only a bit in shape and size. In this embodiment, the nut 101 is applied to a side-fastened toilet 40a or all-in-one toilet. A contact area of the compression wall 135 is increased to improve installation and fastening strength. A pull area of each of the pulled surface 153 is also increased and this helps applying force for turning operation.

More particularly, when two fastening bolts 401 mounted and fixed on a toilet flange 43 in advance are inserted through two corresponding assembly holes 441 on a bottom wall 44 of the side-fastened toilet 40a from bottom to top, installers pass the two nuts 101 of this embodiment through operation holes on two side walls 45 of the side-fastened toilet 40a, place the two nuts 101 on the fastening bolts 401 and run the nuts 101 down the fastening bolts 401 fast for threading and fastening the side-fastened toilet 40a with the toilet flange 43 and surrounding floors 46 quickly.

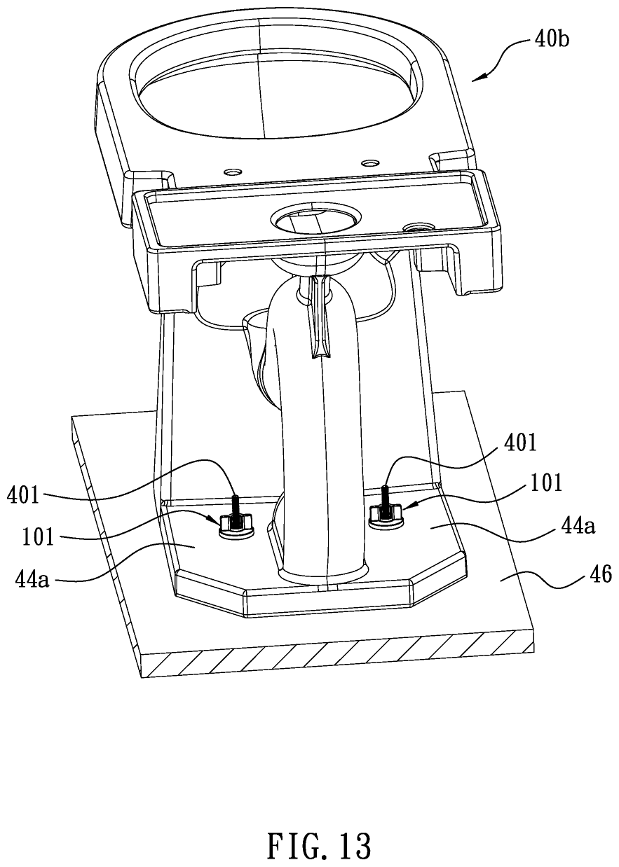

As shown in FIG. 13, the nut 101 can also be applied to a toilet with exposed drain pipes 40b. That means after fastening bolts 401 on the toilet 43 being pointing upward and inserted through two opposite assembly holes 441 on two side saddle portions 44a of the toilet with exposed drain pipes 40b, installers place the two nuts 101 of this embodiment on the fastening bolts 401 and move the nuts 101 down the fastening bolts 401 fast for fastening and fixing the toilet with exposed drain pipes 40b on the toilet flange 43 and surrounding floors 46 quickly.

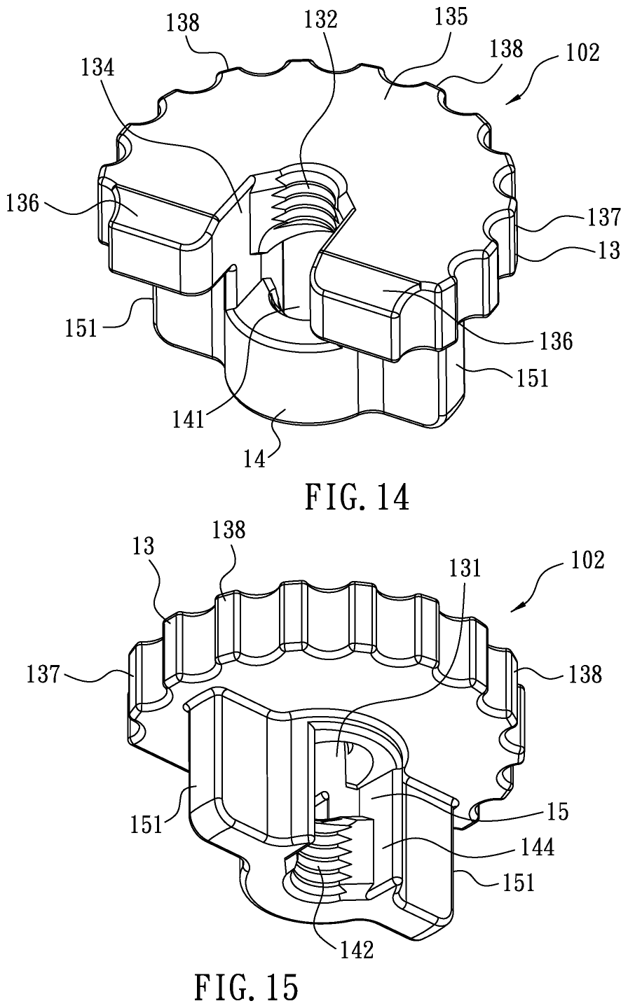

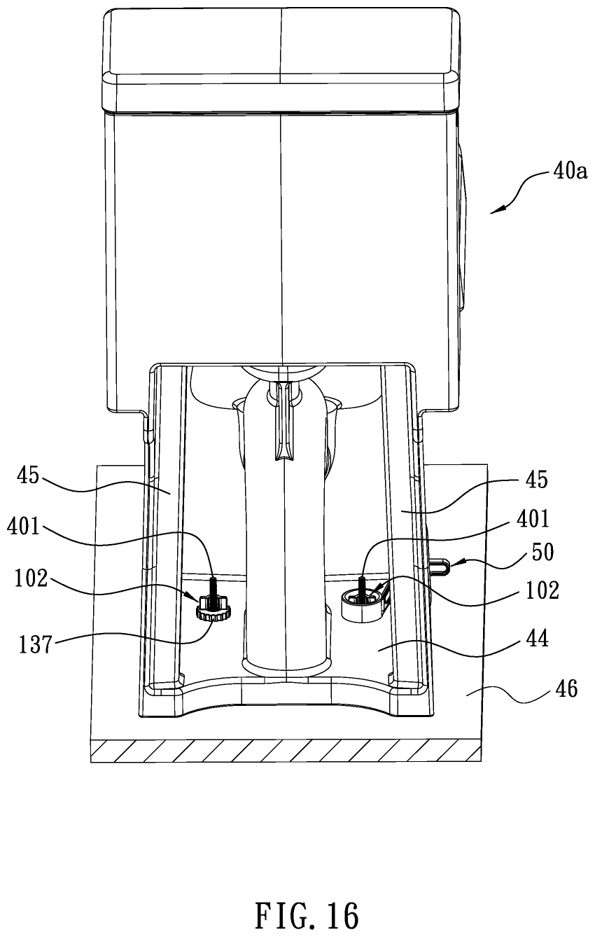

Refer to FIG. 14-16, a third embodiment of a quick install nut according to the present invention is provided. A nut 102 is about the same as the nut 101 of the second embodiment mentioned above and also able to be used in the side-fastened toilet 40a or all-in-one toilet. The difference between this embodiment and the second embodiment is only in that an outer peripheral wall of the first threaded portion 13 of the nut 102 of this embodiment is provided with a mounting-and-locking peripheral wall 137 for allowing a wrench tool 50 to mount and hold. In a preferred embodiment, a plurality of teeth 138 for mounting and locking is formed on the mounting-and-locking peripheral wall 137. The wrench tool 50 can be a specific tool able to be inserted into an operation hole on each of the two side walls 45 of the side-fastened toilet 40a and mounted on the mounting-and-locking peripheral wall 137 of the nut 102 for turning and tightening the nut 102 instead of manual operation in the second embodiment. Thereby installation of the nut 102 is easier and more labor saving.

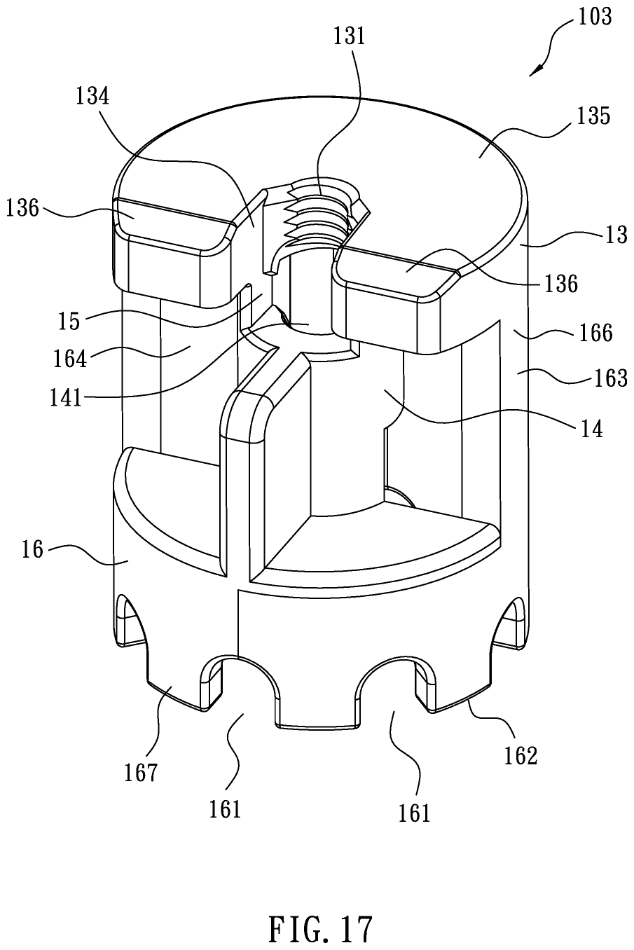

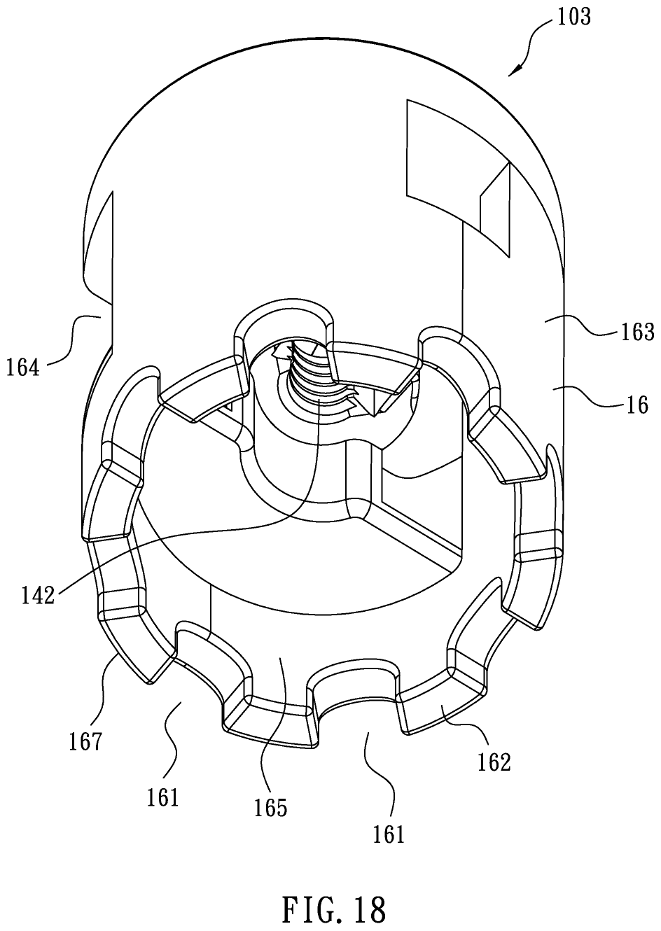

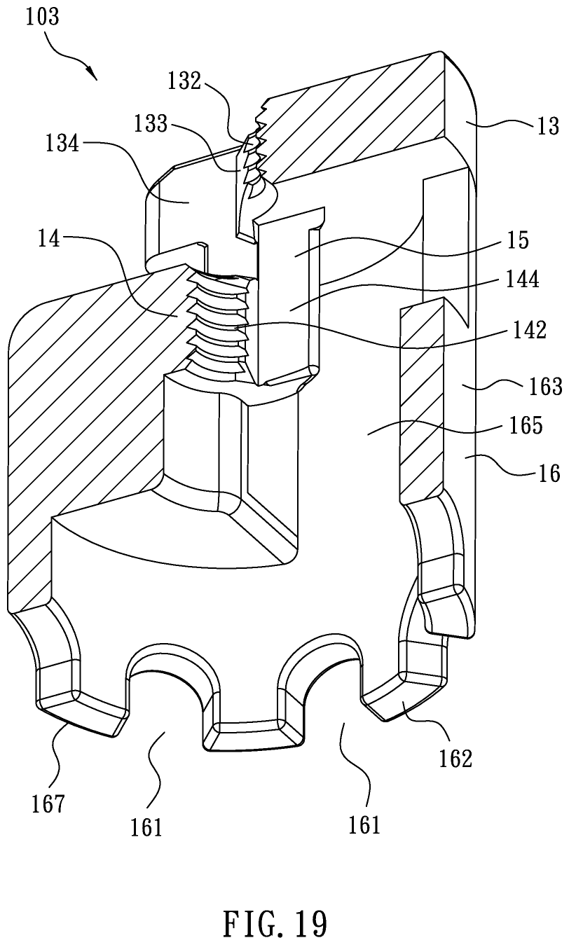

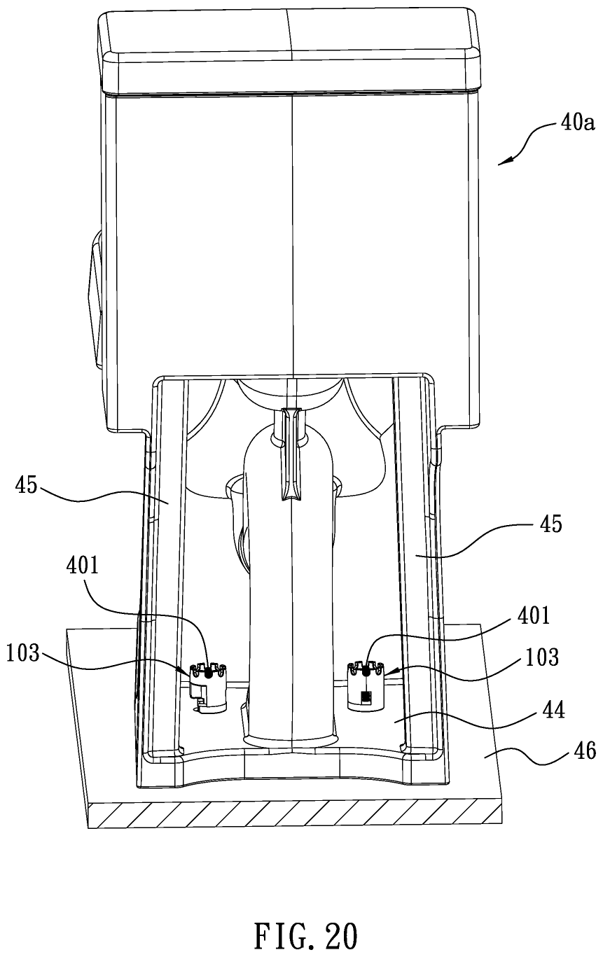

Refer to FIG. 17-20, a fourth embodiment of a quick install nut according to the present invention is provided. A nut 103 is about the same as the nut 101 of the second embodiment mentioned above and also able to be used in the side-fastened toilet 40a or all-in-one toilet. The difference between this embodiment and the above second embodiment is only in that the nut 103 of this embodiment further includes a locking portion 16 which is disposed on a periphery of the second threaded portion 14 and provided with a plurality of locking slots 161. A wrench tool such as a flathead or Phillips screwdriver is mounted in the two opposite locking slots 161 to turn the nut 103.

More particularly, the locking portion 16 is further provided with a circular wall 162 formed on an end of the locking portion 16 opposite to an end of the locking portion 16 with the second threaded portion 14 and the locking slots 161 are formed on the circular wall 162.

In a preferred embodiment, the locking portion 16 includes a housing 163, a notch 164 formed on the housing 163, and a cavity 165 defined in the housing 163 and communicating with the notch 164. The housing 163 is provided with a first side 166 and a second side 167. The first side 166 is connected with the first threaded portion 13 while the circular wall 162 is formed on the second side 167. An inner peripheral surface of the housing 163 is connected with an outer peripheral surface of the second threaded portion 14. The first relief space 134 is located on one side of the nut 103 with the notch 164 and the second relief space 144 is located inside the cavity 165.

In this embodiment, the nut 103 is turned and tightened by the flathead or Phillips screwdriver being inserted through each of the operation holes on the two side walls 45 of the side-fastened toilet 40a to be mounted in the two opposite locking slots 161 of the nut 103 for tightening the nut 103, instead of manual operation in the second embodiment. Thereby installation of the nut 103 is easier and more labor saving.

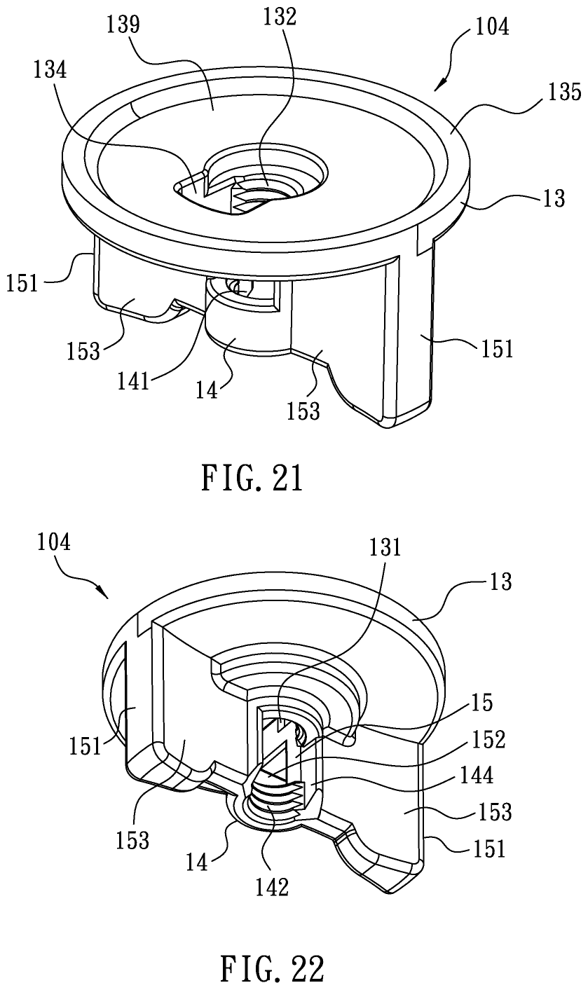

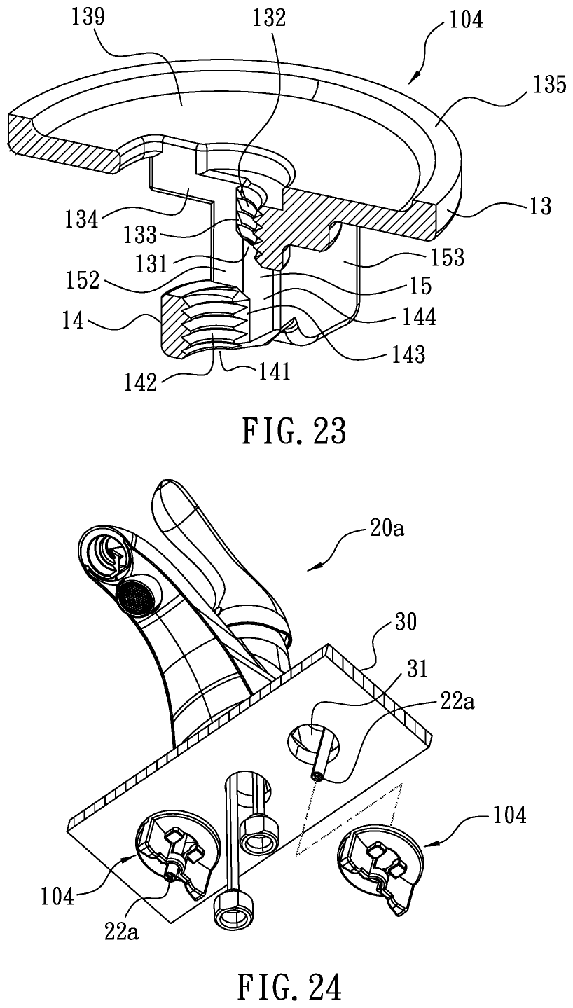

Refer to FIG. 21-24, a fifth embodiment of a quick install nut according to the present invention is provided. A nut 104 is about the same as the nut 10 of the first embodiment mentioned above and also able to be used in installation of similar faucets, especially installation of a faucet 20a for double-hole double-shank basins. The difference between this embodiment and the first embodiment is only in that the nut 104 of this embodiment has a flat and wide profile, especially having the wider pulled surface 153 suitable for a narrower space and providing more labor-saving turning operation. A top end of the first threaded portion 13 is designed to have a circular surface 139 with a larger diameter and the ring-shaped compression wall 135 is formed on a periphery of the circular surface 139 for improving stability and firmness after fastening.

While being assembled, threaded rods 22a fixed on left and right sides on a bottom of the faucet 20a in advance are inserted through the assembly holes 31 on left and right sides of the basin 30 and then the two nuts 104 are placed on the threaded rods 22a correspondingly and run down the threaded rods 22a fast for installing and fastening the faucet 20a on the basin 30 quickly.

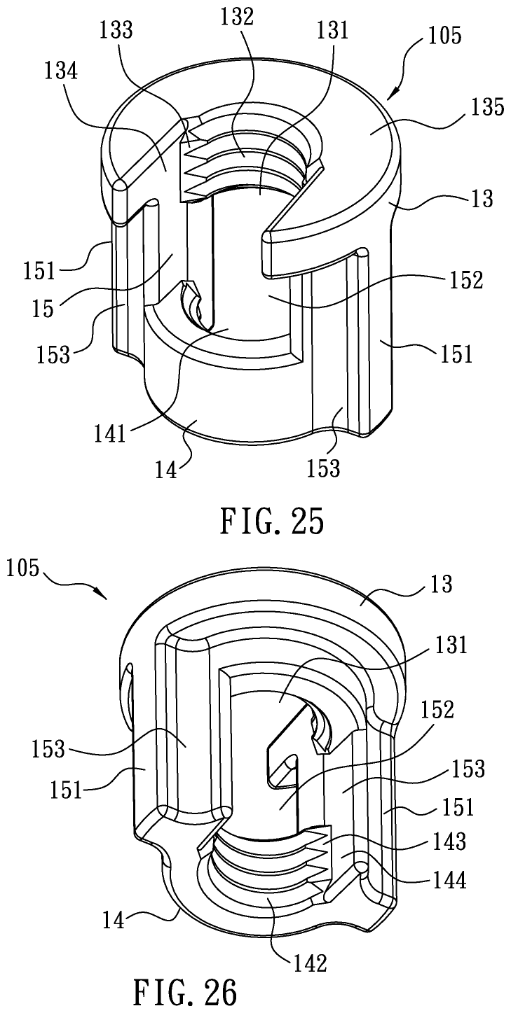

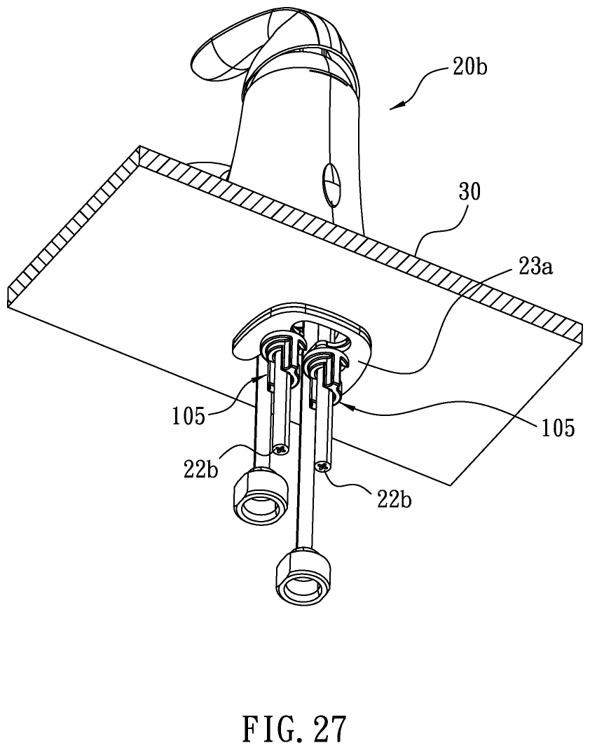

Refer to FIG. 25-27, a sixth embodiment of a quick install nut according to the present invention is provided. A nut 105 is about the same as the nut 10 of the first embodiment mentioned above and also able to be used in installation of similar faucets, especially installation of a faucet 2b for single-hole double-shank basins. The difference between this embodiment and the first embodiment is only in that the nut 105 of this embodiment must be able to install in a narrow space, without in contact with surrounding water supply pipelines and adjacent threaded rods in order to be used for the single-hole double-shank basins. Thus the nut 105 has a thin and tall style without the design of the slanting surface 136 to ensure both smooth installation and firmness.

During assembly, insert the left and right threaded rods 22b fixed on the bottom of the faucet 20b in advance through the corresponding assembly holes 31 of the basin 30 and corresponding gaskets 23a. Then place the two nuts 105 of this embodiment on the corresponding threaded rods 22a and run down the threaded rods 22a fast for assembling and fastening the faucet 20b on the basin 30 quickly.

According to the above embodiments, the present quick install nut has following advantages and features.

Firstly, the present nut with a certain tilted angle can be placed and moved fast on/along various threaded fasteners such as bolts, threaded rods, or threaded inserts without hindrance. Then threading and fastening with extremely short movement is performed by being returned to the original direction. Thereby fastening or clamping is achieved quickly and the nut is especially suitable for installation and fastening of bathroom equipment or accessories (such as various types of faucets and toilets). The time required for threading of long threads is significantly reduced. The nut is not only easy to install but also ensures firmness and durability of the fastening.

By the first relief space 134 and the second relief space 144 formed at corresponding positions of the first internal thread 132 and the second internal thread 142, and the crossing space 152 formed between the first threaded portion 13 and the second threaded portion 14, the nut can be directly produced by molding of plastic materials with molds. Conventional nuts are unable to be produced by molds due to draft angle and thus only able to be produced by metal processing. The design of the present nut can overcome the above problem and have many advantages including fast production, lower cost of materials and manufacturing, light weight, etc.

By the design of the slanting surface 136 formed on each of two ends of the compression wall 135 of the first threaded portion 13, the nut is getting closer to the surface going to be compressed while moving on the threaded fastener. Thus rotation movement required for threading and fastening after the nut being returned to the original direction is reduced and assembly speed is further increased.

By the mounting-and-locking peripheral wall 137 or the locking portion 16 on the nut 102, 103, the installers can perform final threading and tightening using the specific wrench tool 50 or general wrench tools. Thus specific operation and installation are more convenient, labor-saving, fast and firm.

By open design of the first relief space 134, and the crossing space 152, the present nut is allowed to have the tilted angle with larger range in response to nuts designed with different sizes and specifications and various installations and applications, without worrying about relief effect. The relief effect of the nut is much better than conventional quick fastening nut.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. A quick install nut comprising: an entrance end, an exit end, a half-shell first threaded portion corresponding to the entrance end, and a half-shell second threaded portion corresponding to the exit end and connected with the first threaded portion; wherein the first threaded portion includes a first slot, a segment of first internal thread formed on an inner surface of the first slot, and a first relief space communicating with a radial opening of the first slot; wherein the second threaded portion is composed of a second slot, a segment of second internal thread formed on an inner surface of the second slot, and a second relief space communicating with a radial opening of the second slot; wherein the first slot and the second slot are disposed on a central axis of the quick install nut in a staggered manner so that the radial openings of the first and the second slots are in opposite directions with a 180-degree angle between the radial openings; wherein a compression wall is formed on the first threaded portion.

2. The quick install nut as claimed in claim 1, wherein the first threaded portion and the second threaded portion have a distance on the central axis between them and connected with each other by a connecting portion.

3. The quick install nut as claimed in claim 2, wherein the connecting portion includes two connection ribs correspondingly connected with two corresponding sides of the first threaded portion and the second threaded portion; a crossing space is defined among the connection ribs and adjacent area for communicating with the first slot, the first relief space, the second slot, and the second relief space.

4. The quick install nut as claimed in claim 3, wherein each of the connection rib is provided with a pulled surface for manual turning and operation.

5. The quick install nut as claimed in claim 3, wherein the connection rib is further extending and connected to outer wall surfaces on two opposite sides of the second threaded portion.

6. The quick install nut as claimed in claim 1, wherein the first internal thread on the inner surface of the first slot and the second internal thread formed on the inner surface of the second slot are distributed without over a semicircle in a circumferential direction.

7. The quick install nut as claimed in claim 1, wherein the compression wall of the first threaded portion is U-shaped and provided a slanting surface formed on each of two ends of the compression wall.

8. The quick install nut as claimed in claim 1, wherein an outer peripheral wall of the first threaded portion is provided with a mounting-and-locking peripheral wall for allowing a wrench tool to mount and hold.

9. The quick install nut as claimed in claim 8, wherein a plurality of teeth for mounting and locking is formed on the mounting-and-locking peripheral wall.

10. The quick install nut as claimed in claim 1, wherein the quick install nut further includes a locking portion which is disposed on a periphery of the second threaded portion and provided with a plurality of locking slots; a wrench tool is mounted in the two opposite locking slots for turning operation.

11. The quick install nut as claimed in claim 10, wherein the locking portion is further provided with a circular wall formed on an end of the locking portion opposite to an end with the second threaded portion and the locking slots are formed on the circular wall.

12. The quick install nut as claimed in claim 11, wherein the locking portion includes a housing, a notch formed on the housing, and a cavity defined in the housing and communicating with the notch; the housing is provided with a first side and a second side which are respectively connected with the first threaded portion and the circular wall; an inner peripheral surface of the housing is connected with an outer peripheral surface of the second threaded portion; the first relief space is located on one side of the nut with the notch and the second relief space is located in the cavity.

13. The quick install nut as claimed in claim 12, wherein the first threaded portion and the second threaded portion are having a distance on the central axis between them and connected with each other by a connecting portion; the connecting portion includes two connection ribs correspondingly connected with two corresponding sides of the first threaded portion and the second threaded portion; a crossing space is defined among the connection ribs and adjacent area and used for communicating with the first slot, the first relief space, the second slot, and the second relief space.

14. The quick install nut as claimed in claim 1, wherein a top end of the first threaded portion is provided with a circular surface and the compression wall in a ring shape is formed on a periphery of the circular surface.
